(19) United States
(12) Patent Application Publication
(10) Pub. No.: US 2006/0092400 A1
(43) Pub. Date: May 4, 2006

(54) Printing system for use with microencapsulated media

(75) Inventors: YuanQiao Rao, Pittsford, NY (US); Yongcai Wang, Webster, NY (US); Joseph S. Sedita, Albion, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/977,847

(22) Filed: Oct. 29, 2004

(51) Int. Cl. G03B 27/00

(52) U.S. Cl. 355/400; 430/138

(57) ABSTRACT

A printing system having a printer that is adapted to develop images on microencapsulated media. The printing system includes a pressure applicator that includes micro-features that are adapted to contact the media to develop images on the media. The invention provides for improved image quality while enabling the use of a media that is made of inexpensive fiber based natural paper.

### CROSS REFERENCE TO RELATED APPLICATIONS

Reference is made to commonly-assigned copending U.S. patent application Ser. No. 10/799,267, filed Mar. 12, 2004, entitled PRESSURE DEVELOPMENT APPARATUS, by Gao et al., the disclosure of which is incorporated herein.

### FIELD OF THE INVENTION

The present invention relates to a printing system having a printer that is adapted to develop images on microencapsulated media. The printing system according to the invention provides for improved image quality while enabling the use of a media that is made of inexpensive fiber based natural paper.

### BACKGROUND OF THE INVENTION

Image-forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

U.S. Pat. No. 5,550,627A describes an exposure and pressure applicator for photosensitive microencapsulated media. The pressure applicator in this patent uses a point force to rupture microcapsules on microencapsulated media.

U.S. Pat. No. 4,885,601A discloses a rotatable roller having a rotational axis perpendicular to a transport direction of photosensitive microencapsulated media. Thus, the capsule ruptures when the roller is rotated over the surface of the media.

To achieve acceptable print quality, such as good image optical density uniformity, the use of the above mentioned different means of applying pressure required a specifically designed media structure.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The media further comprises a monomer and the appropriate cyan, magenta or yellow photo initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leuco dye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is uniformly applied across the image. As a final fixing step, heat is applied to accelerate color development and to extract all un-reacted liquid from the microcapsules. This heating step also serves to assist in the development of available leuco dye for improved image stability. Generally, pressure ruptured capsules (unhardened) expel lueco dye into the developer matrix.

Recent developments in media design (or the imaging member) as described in co-pending U.S. application Ser. No. 10/687,939 have changed the prior art structure of the imaging member to the point where the aforementioned means of processing may no longer be robust. The use of a substantially non-compressible top clear polymer film layer and a rigid opaque backing layer which serves to contain the image forming layer of conventional media presented a processing position whereby balls, micro wheels or rollers could be used without processing artifacts such as scratch, banding, or dimensional or surface deformation. In addition, the non-compressibility of this prior art structure provided more tolerance to processing conditions. The recent imaging member embodiment as described in the above-mentioned co-pending patent application, replaces the top and bottom structures of the media with highly elastic and compressible materials (gel SOC) (super over coat or top most clear gel comprising layer) and non-rigid opaque backing such as synthetic paper (polyolefin) or natural cellulose fiber based paper. The fiber-based media as described in the above-mentioned co-pending application may no longer survive these means of processing in a robust fashion where pressure is applied by a roller or ball. This is due to the fact that in the imaging member described in the co-pending application, the backing of polyolefin or natural cellulose fiber based paper present non uniform density, and the high compression forces required for processing in the conventional arrangements may make an “image” of the fiber pattern in the print, thus making the print corrupt.

Natural cellulose fiber based paper as described above is advantageous to use as the substrate to the microencapsulated media because it is inexpensive and readily available. However the base material is not continuous, thus microscopically there is a local modulus difference varying from the modulus of fiber to the modulus of air. When the above-mentioned conventional pressure applicators are used, the generated pressure on the microcapsules is different from location to location. Non-uniform rupture is thus introduced and leads to non-uniform optical density with the same exposure.

Therefore, there is strong need for a new means of applying pressure to enable the use of inexpensive fiber based media. Further, it would be desirable to have a pressure applicator that provides improved image density uniformity when a fiber-based substrate is used for photosensitive microencapsulated media.

### SUMMARY OF THE INVENTION

It is an object of the invention to overcome the disadvantages of previous pressure applicators for photosensitive microencapsulated media.

It is another object to provide a pressure applicator that provides improved image optical density uniformity.

It is yet another object to provide for a printing system that enables the use of inexpensive fiber-based paper backing for microencapsulated media.

These and other objects of the invention are accomplished by a printing system that comprises a pressure applicator that is adapted to develop images on fiber-based microencapsulated media where the area of immediate pressure contact is less than 400 microns.

The invention provides for a printing system that generates high-resolution photo quality prints while using inexpensive fiber-based paper for the backing of the microencapsulated media, and a pressure applicator that uses less force than conventional pressure applicators.

The present invention further provides for a printing system that does not invoke the conventional method of utilizing high compression forces, to provide a high quality image by improving the tonal scale development and minimizing density formation by the imaging member. The printing system of the invention further uses plain paper as a substrate, is low in cost, is fully extensible, and is mechanically simple and robust.

The present invention therefore relates to a printing system for developing images on fiber-based microencapsulated media. The printing system comprises an imaging member adapted to form a latent image on a fiber-based microencapsulated media; and a pressure applicator adapted to develop the latent image, with the pressure applicator comprising at least one spring loaded roller and a micro-bead array provided adjacent to the spring loaded roller, and the micro-bead array contacting a surface of the fiber-based microencapsulated media with a pressure sufficient to release imaging material from selected microcapsules of the fiber-based microencapsulated media.

The present invention further relates to a printing system for developing images on fiber-based microencapsulated media which comprises fiber-based microencapsulated media; an imaging member adapted to form a latent image on the fiber-based microencapsulated media; and a pressure applicator adapted to develop the latent image, with the pressure applicator comprising a roller having an outer surface which includes a plurality of micro-features thereon. Each of the micro-features extend from the outer surface of the roller and have a size which is 400 microns or less. The micro-features being provided on the outer surface of the roller in a random pattern and being adapted to contact a surface of the fiber-based microencapsulated media with a pressure sufficient to release imaging material from selected microcapsules of the fiber-based microencapsulated media.

The present invention further relates to a printing system for developing images on fiber-based microencapsulated media which comprises an imaging member adapted to form a latent image on a fiber-based microencapsulated media; and a pressure applicator adapted to develop the latent image, with the pressure applicator comprising a device having elements thereon that are adapted to contact a surface of the fiber-based microencapsulated media with a pressure sufficient to release imaging material from selected microcapsules of the fiber-based microencapsulated media, and wherein a contact area between each of the elements and the surface of the media is 400 microns or less.

### BRIEF DESCRIPTION OF THE DRAWINGS

FIG. 1A schematically shows an image-forming device;

FIG. 1B schematically shows an example of a pressure applying system that can be used in the image-forming device of FIG. 1A;

FIG. 2 schematically shows an image-forming device in accordance with a first feature of the invention;

FIGS. 3A-3B illustrate an example of a printing head in the form of a point force contact pressure applicator in accordance with a first feature of the present invention;

FIGS. 4A-4C illustrate a micro-bead array which includes plural micro-beads that can be arranged in different patterns in accordance with the present invention;

FIGS. 5A-5C illustrate an example of a pressure roller having a micro-features thereon;

FIG. 6 is an example of a pressure applicator including a pressure roller described in FIGS. 5A-C; and

FIG. 7 is an example of a further embodiment of a pressure applicator including a pressure roller described in FIGS. 5A-C in accordance with the present invention.

### DETAILED DESCRIPTION OF THE INVENTION

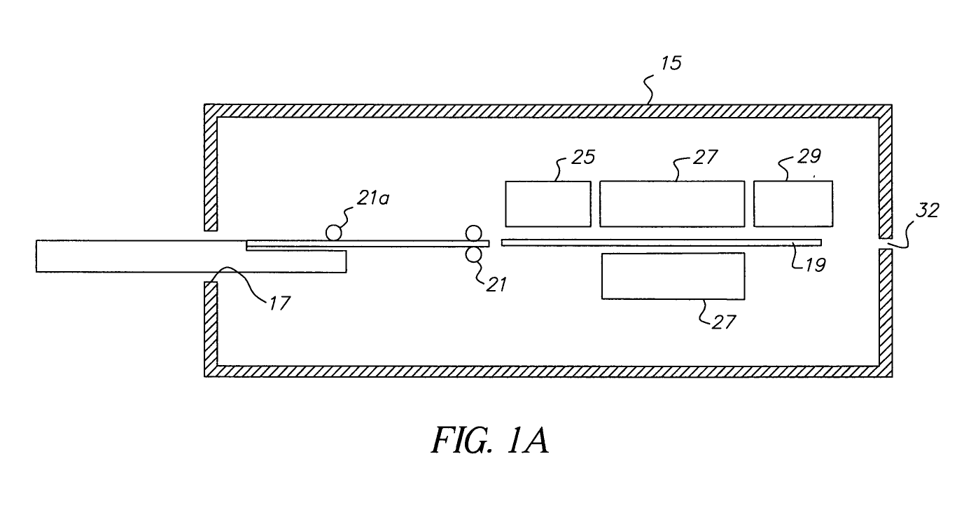

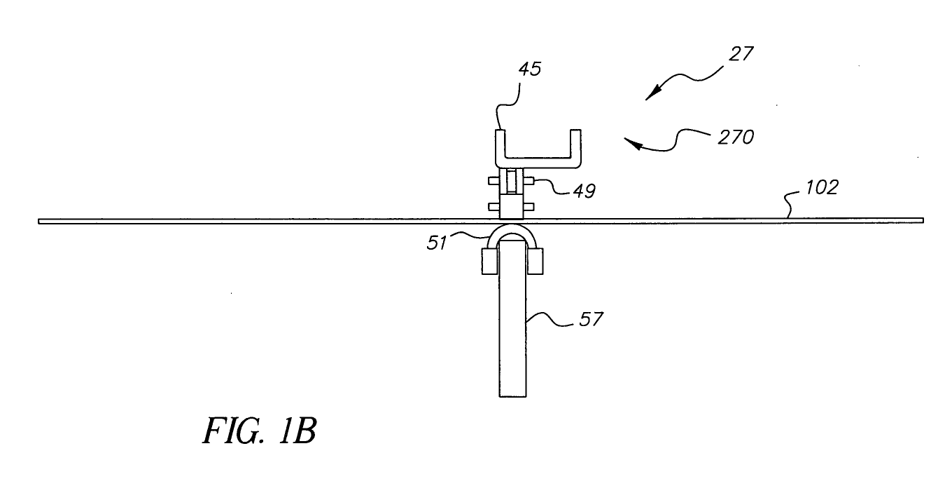

Referring now to the drawings, wherein like reference numerals represent identical or corresponding parts throughout the several views, FIG. 1A is a schematic view of an image-forming device 15 pertinent to the present invention. Image-forming device 15 could be, for example, a printer that includes an opening 17 that is adapted to receive a cartridge containing photosensitive media. As described in U.S. Pat. No. 5,884,114, the cartridge could be a light tight cartridge in which photosensitive sheets are piled one on top of each other. When inserted into image-forming device 15, a feed mechanism that includes, for example, a feed roller 21a in image-forming device 15, working in combination with a mechanism in the cartridge, cooperate with each other to pull one sheet at a time from the cartridge into image-forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image-forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator or pressure assembly, wherein an image such as a color image is formed based on the image information by applying pressure to microcapsules having imaging material encapsulated therein to crush unhardened microcapsules. As discussed above, the pressure could be applied by way of spring-loaded balls, micro wheels, micro rollers, rolling pins, etc.

FIG. 1B schematically illustrates an example of a pressure applicator 270 for processing assembly 27 which can be used in the image-forming device of FIG. 1A. In the example of FIG. 1B, pressure applicator 270 is a crushing roller arrangement that provides contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush unhardened microcapsules and release coloring material. Further examples of pressure applicators or crushing members that can be used in the image-forming device of FIG. 1A are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

As described above, the conventional method of applying pressure to microencapsulated media provides for image artifacts if this pressure is applied to microencapsulated media made of fiber-based paper backing. The present invention overcomes this drawback by providing for a printing system that comprises a printer and fiber based microencapsulated media, wherein the printing system includes a pressure applicator that is enabled to develop images on fiber-based microencapsulated media without creating image artifacts.

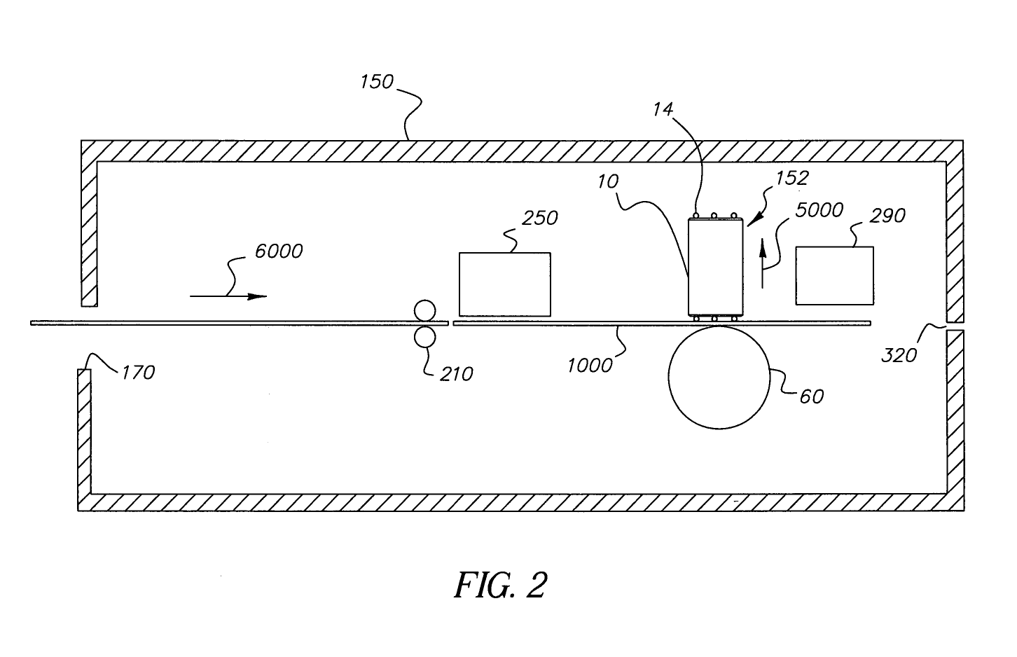

An image-forming device 150 in accordance with a first feature of the invention is schematically shown in FIG. 2. Image-forming device 150 is similar to image-forming device 15 in FIG. 1A except for the processing member, pressure application device, or pressure development member. More specifically, image-forming device 150 can be adapted to accept fiber-based microencapsulated media as described in for example, co-pending U.S. application Ser. No. 10/687,939, through an opening 170, while a roller 210 can be adapted to convey the media to an imaging member 250. Imaging member 250 can be an imaging head that includes a plurality of light-emitting elements adapted to expose a latent image on the media based on image information. After the latent image is formed, the media is conveyed passed a processing assembly or a pressure development or application member 152 in accordance with the present invention. As will be described, development member 152 preferably comprises a pressure application member 10 that includes an array of micro-features and a backing member 60, which can be an opposing platen roller, an opposing beam or a surface having a width that generally matches the width of the media. The microfeatures are adapted to contact microencapsulated photosensitive medium 1000 when it travels between member 10 and backing member 60.

The arrangement of the present invention is advantageous for processing media such as disclosed in co-pending application U.S. application Ser. No. 10/687,939, since a sufficient force to rupture the capsules is created. The present invention also permits the use of a low cost fiber based media since the processing can be restricted to the microcapsules and any deformation or patterning caused by density differences in the support sheet and read out in the development of the media due to the resulting differential pressures is of no consequence.

Therefore, in a feature of the present invention, the combination of a pressure applicator or developer design and the control of the pressure applicator are utilized to provide for a printing system that is adapted to print on inexpensive fiber based microencapsulation material and provide a high resolution photo quality print. The pressure application feature of the present invention is based on the Hertzian contact theory. According to the Hertzian contact theory, when a point force is applied to a surface by a ball or roller,

[image]

where P is force, E is modulus, R₂ is the radius of the ball.

There is a pressure distribution depending on how far the location is away from the contact point. The stress becomes insensitive to the modulus of the material when the location is farther from the contact point, e.g. over 3 times of the displacement as shown in the above graph. Therefore, in a multilayered structure, when a small contact area is used, the substrate property becomes insignificant to alter the pressure seen by the top layer of microcapsules.

It has been found in the present invention that when the feature size of the pressure applicator is smaller than 400 microns, the substrate effect diminishes.

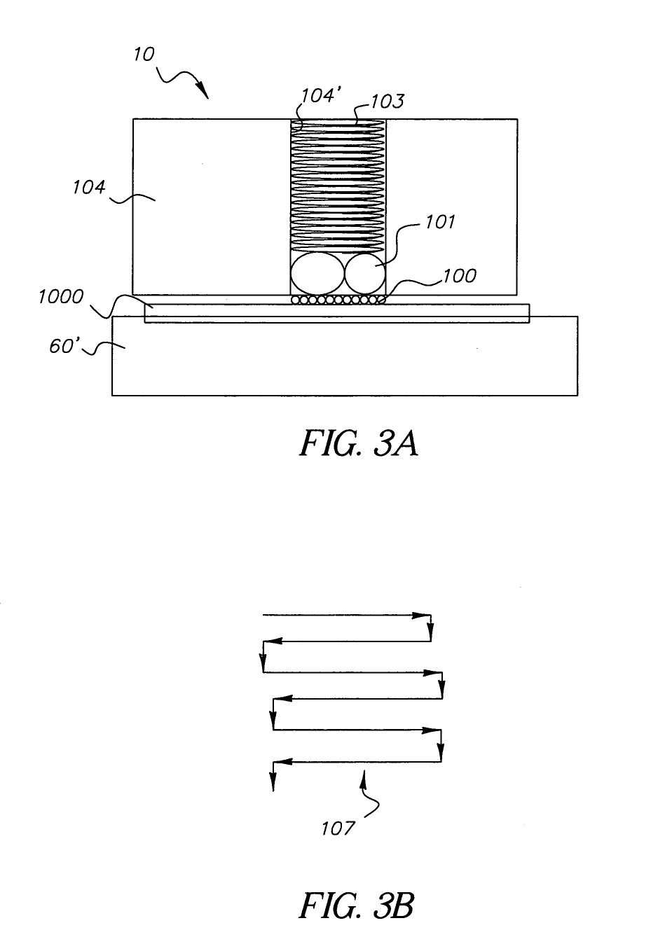

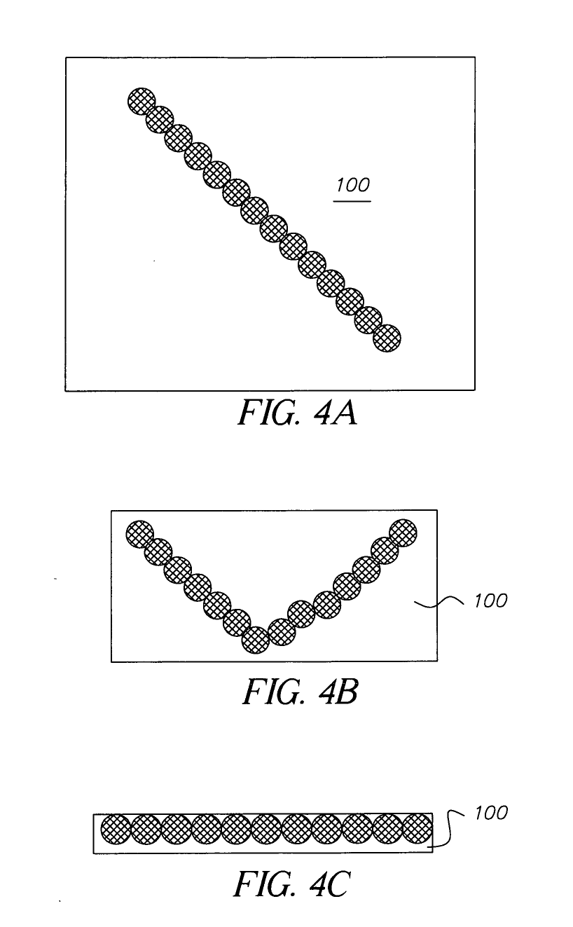

FIG. 3A is an example of a pressure applicator 10 in the form of a print head in accordance with a first feature of the present invention. In the embodiment of FIG. 3A, the application of pressure is based on the contact theory referenced above. Pressure applicator 10 comprises a holder or device 104 as shown. Holder 104 includes an opening 104′ that is sized to hold a spring arrangement 103 and a self rotating pair of rollers 101. Rollers 101 could be balls or cylindrical or spherical type members. An array of elements or microfeatures in the form of micro-beads 100 is placed in holder 104, with the micro-beads 100 being compressed by spring load 103 through the self-rotating pair of rollers 101. The micro-bead array 100 is pressed against fiber-based microencapsuled media 1000 for development of images on media 1000. The backside of media 1000 is supported by an opposing member which in the example of FIG. 3A is a flat platen 60′. The printing head including pressure applicator 10 is then adapted to move in a scanning pattern 107 as shown in FIG. 3B to generate a full crushing of the print. The micro-bead array 100 that includes plural micro-beads can be arranged in different patterns as shown in FIGS. 4A, 4B and 4C. The patterns shown in FIGS. 4A-4C are examples and it is recognized that the beads can be assembled in numerous further patterns. Within the context of the present invention, the diameter of the individual micro-beads is smaller that the diameter of the rotating rollers and preferably smaller than 400 microns.

Within the context of the invention, an individual contact area is the area of contact between an individual micro-bead and the surface of the media. The above examples relate to the case where you have an individual circular contact area for each bead, such that the contact area is defined as a circular contact area and has a diameter of less than 400 microns. However, the present invention is not limited to circular contact areas and it is recognized that the contact area and bead can take the form of various geometries, can be defined by a regular pattern or can be defined by an irregular pattern. In the case of a non-circular regular or irregular contact area, the dimension of the non-circular contact area would essentially be the largest dimension where there is contact between the bead and the media. This largest dimension is preferably less than 400 microns.

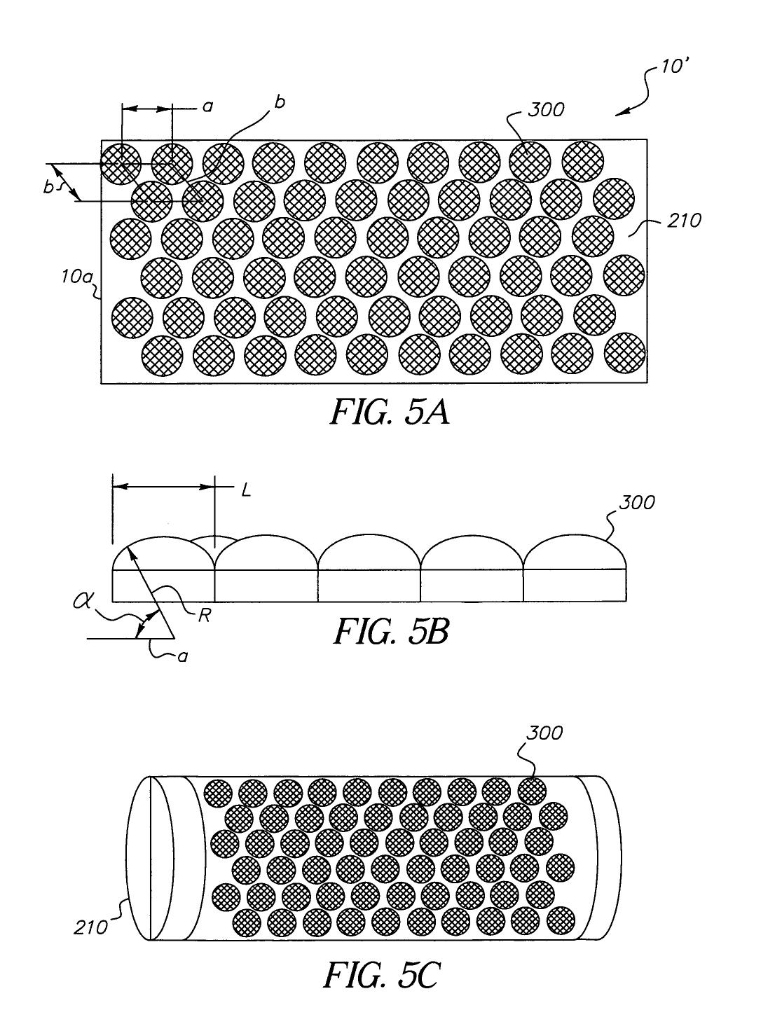

FIGS. 5A-5C illustrate an embodiment of a pressure applicator 10′ in accordance with a further feature of the present invention. Pressure applicator 10′ is preferably a device in the form of a roller 210 (FIG. 5C) and includes elements such as micro-features 300 on the outer surface of the roller. A group of micro-features 300 as shown in FIG. 5A can generally define a rectangular contact area 10a as also shown in FIG. 5A. The pressure applicator 10′ is adapted to contact the fiber based media as the media travels between applicator 10′ and a backing roller. The individual microfeatures 300 preferably have a diameter L that is equal to or smaller than 400 microns such that each micro-feature can define an individual contact area with the media of 400 microns or less. The arrangement of the microfeatures 300 is random and FIG. 5A just shows one example of an arrangement where there is a distance “a” between the center of adjacent microfeatures 300 that extends along an axis parallel to the rotational axis of the roller 210 and a distance “b” that extends between the center of adjacent micro-features at an angle to the longitudinal direction as shown in FIG. 5A. As illustrated in FIGS. 5B and 5C, the microfeatures can define generally spherical surfaces with a height dictated by the radius R, where the ratio of R and a is less than 10 and angle α is defined between R and a.

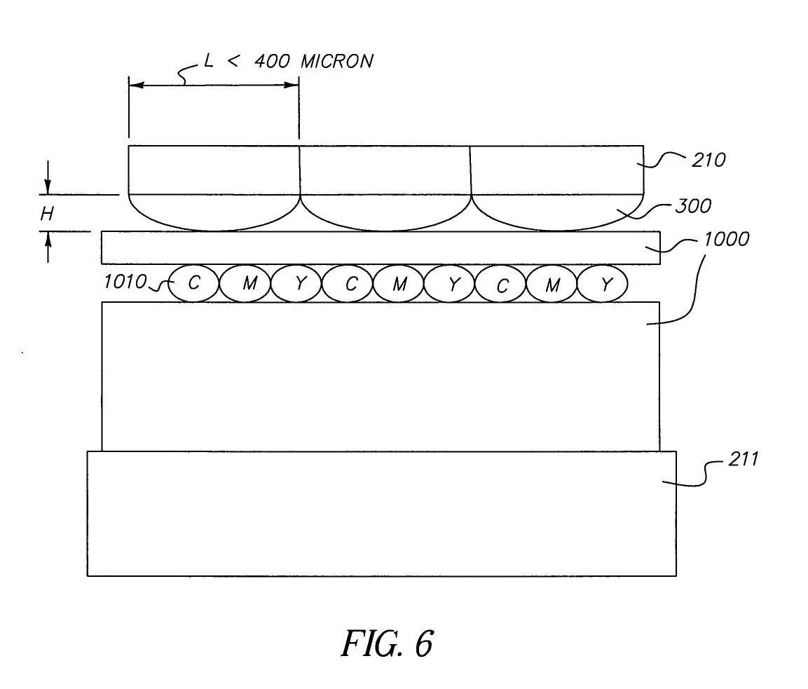

FIG. 6 illustrates, in a parallel roller arrangement, how roller 210 of applicator 10′ is in contact with the photosensitive microencapsulated media 1000. In a feature of the present invention, two pressure rollers 210 and 211 are used where roller 210 is with the micro-features 300 as described in FIGS. 5A to 5C, and roller 211 has a flat surface. Rollers 210 and 211 are arranged in a parallel format with an opening to accept microencapsulated media 1000 having microcapsules 1010. During processing, the distance between the peripheral surface of the roller 210, which is the surface where micro-features reside on, and the top of the media 1000 is H. Multiple rollers 210 can be also used with one behind the other with respect to a direction of movement of the media, and the rollers being offset from each other to compensate for any uncontacted area between the microfeatures. The rollers 210 and 211 can be rotated at the same rate or different rate where roller 210 rotates faster.

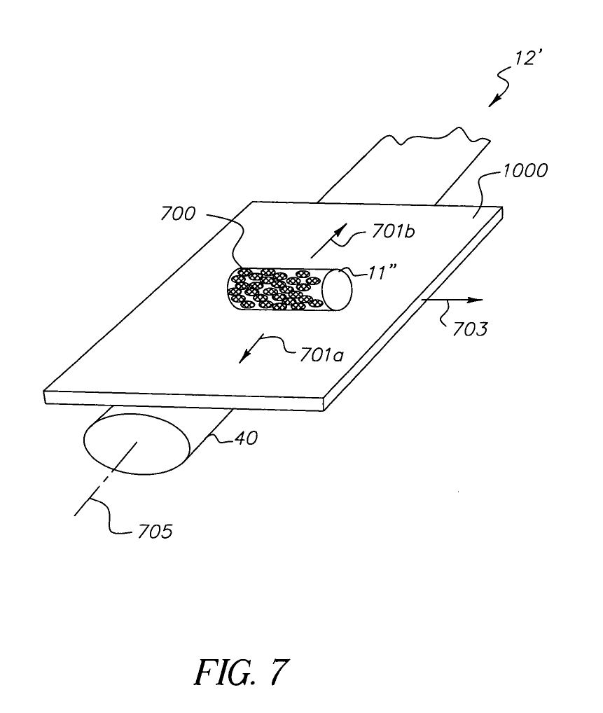

FIG. 7 is an example of a further embodiment of a pressure applicator 12″ and generally defines an elliptical contact area in a cross roller arrangement. A roller 11″ as shown includes microfeatures 700 thereon, and it is designed to be conveyed in directions 701a and 701b, which is perpendicular to a conveying direction 703 of the fiber-based media 1000. The micro-features 700 as in the previous embodiment are each preferably smaller than 400 microns so as to provide for individual contact areas with the media of 400 microns or less. As shown in FIG. 7, the media travels between roller 11″ and a bottom member 40 which can be a bottom roller of large diameter or a bottom platen. The media is transported in direction 703 perpendicular to axis 705 of the bottom roller or platen. The top roller 11′ is then rotated and moved along direction 701a, 701b perpendicular to conveying direction 703 of the media. After one line scanning, the top roller 11′ is moved by a distance along the media transport direction 703 and continuous scanning is carried out.

Therefore, the present invention provides for pressure applicator designs which enable the use of low cost fiber based microencapsulated media and enable the development of images which have a uniform density.

The invention has been described in detail with particular reference to certain preferred embodiments thereof, but it will be understood that variations and modifications can be effected within the spirit and scope of the invention.

1. A printing system for developing images on fiber-based microencapsulated media, the printing system comprising:
an imaging member adapted to form a latent image on a fiber-based microencapsulated media; and
a pressure applicator adapted to develop the latent image, said pressure applicator comprising at least one spring loaded roller and a micro-bead array provided adjacent to said spring loaded roller, said micro-bead array contacting a surface of said fiber-based microencapsulated media with a pressure sufficient to release imaging material from selected microcapsules of said fiber-based microencapsulated media.

2. A printing system according to claim 1, wherein said pressure applicator comprises a holder having an opening therein which is size to hold at least said one spring loaded ball and a spring arrangement that provided a force to said ball.

3. A printing system according to claim 1, comprising a pair of said spring loaded rollers, each of said spring loaded rollers having a diameter of a first size, said micro-bead array comprising a plurality of micro-beads, each of the micro-beads having a diameter of a second size which is smaller than said first size.

4. A printing system according to claim 3, wherein said beads have a diameter of less than 400 microns.

5. A printing system according to claim 1, wherein said micro-bead array comprises a plurality of micro-beads with each of said micro-beads having a diameter of less than 400 microns.

6. A printing system for developing images on fiber-based microencapsulated media, the printing system comprising:
fiber-based micro-encapsulated media;
an imaging member adapted to form a latent image on the fiber-based microencapsulated media; and
a pressure applicator adapted to develop the latent image, said pressure applicator comprising a roller having an outer surface which includes a plurality of micro-features thereon, each of said micro-features extending from the outer surface of said roller and having a size which is 400 microns or less, said micro-features being provided on the outer surface of said roller in a random pattern and being adapted to contact a surface of said fiber-based microencapsulated media with a pressure sufficient to release imaging material from selected microcapsules of said fiber-based microencapsulated media.

7. A printing system for developing images on fiber-based microencapsulated media, the printing system comprising:
an imaging member adapted to form a latent image on a fiber-based microencapsulated media; and
a pressure applicator adapted to develop the latent image, said pressure applicator comprising a device having elements thereon that are adapted to contact a surface of said fiber-based microencapsulated media with a pressure sufficient to release imaging material from selected microcapsules of said fiber-based microencapsulated media, wherein a contact area between each of said elements and the surface of said media is 400 microns or less.
